(19) United States
(12) Patent Application Publication
(10) Pub. No.: US 2025/0370178 A1
(43) Pub. Date: Dec. 4, 2025

(54) LIGHT GUIDE ASSEMBLY FOR USE WITH SPEAKER ASSEMBLY

(71) Applicant: Harman Becker Automotive Systems GmbH, Karlsbad (DE)

(72) Inventors: Henrik Kirkeby JEPSEN, Karlsbad (DE); David MOSSINGTON, Rochester, MI (US)

(21) Appl. No.: 18/733,344

(22) Filed: Jun. 4, 2024

(51) Int. Cl. F21V 8/00; H04R 1/02

(52) U.S. Cl. CPC G02B 6/0006; G02B 6/001; H04R 1/025; H04R 1/028

(57) ABSTRACT

A light guide assembly for use with a speaker assembly includes a light guide including an elongated body having end portions with a central portion therebetween, the body having a post depending downwardly from each end portion. The light guide assembly further includes light boxes removably connectable to the posts, each light box having a light source disposed therein for illuminating the light guide, wherein illumination of the light guide by the light source is controlled in coordination with an operation of the speaker assembly.

### TECHNICAL FIELD

Embodiments relate to a light guide assembly for use with a speaker assembly.

### BACKGROUND

The use of illumination components are increasingly popular in automotive applications as they add sophistication and uniqueness to vehicles. Different types of illumination may include LED lighting, edge lighting, and backlit configurations, to name a few. Such illumination enhances the visual appeal and aesthetics of the vehicle interior, especially in low-light environments. Illumination components can also provide customization and branding opportunities for vehicles as well as in home consumer product uses.

### SUMMARY

In one or more embodiments, a light guide assembly for use with a speaker assembly includes a light guide including an elongated body having end portions with a central portion therebetween, the body having a post depending downwardly from each end portion. The light guide assembly further includes light boxes removably connectable the posts, each light box having a light source disposed therein for illuminating the light guide, wherein illumination of the light guide by the light source is controlled in coordination with an operation of the speaker assembly.

In one or more embodiments, the light boxes are configured to be coupled to the speaker assembly. In one or more embodiments, the light boxes are integrally formed with the speaker assembly. In one or more embodiments, the light source includes at least one programmable LED mounted to and controlled via a printed circuit board (PCB) disposed within each light box. In one or more embodiments, each light box has a generally rectangular housing with a first portion and a second portion removably connected to each other, each light box includes a mounting aperture for receiving the post from the light guide.

In one or more embodiments, the light guide includes a cap configured to be disposed along a top face of the body. In one or more embodiments, at least one of the body and the cap includes a logo thereon. In one or more embodiments, each light box includes a light mixing conduit mounted therein and having a first end adjacent to the light source and a second end adjacent to the post.

In one or more embodiments, the light guide includes prisms on the body to control light emitted from the light guide. In one or more embodiments, the posts include masking elements including one of mirror plating or opaque end caps to prevent light leakage from the end portions of the light guide.

In one or more embodiments, a light guide assembly configured to be mounted to a speaker assembly includes a light guide including an elongated body having end portions with a central portion therebetween, the body having a post depending downwardly from each end portion. The light guide assembly further includes light boxes configured to be coupled to the speaker assembly and removably connectable to each of the posts, each light box having at least one programmable LED mounted to and controlled by a printed circuit board (PCB) for illuminating the light guide. Each light box has a generally rectangular housing with a first portion and a second portion removably connected to each other, and each light box includes a mounting aperture for receiving the post from the light guide to mount the light guide assembly to the speaker assembly.

In one or more embodiments, an audio assembly configured to be mounted to a substrate having a top surface and a bottom surface includes a speaker assembly configured to be mounted below the bottom surface of the substrate, and a light guide assembly. The light guide assembly includes a light guide configured to be disposed above the top surface of the substrate, the light guide including an elongated body having end portions with a central portion therebetween, the body having a post depending downwardly from each end portion and configured to extend through openings in the substrate. The light guide assembly further includes light boxes each including a light source disposed therein for illuminating the light guide, the light boxes configured to be mounted below the bottom surface of the substrate and configured to receive the posts to removably connect the light guide thereto.

In one or more embodiments, the light boxes are coupled to the speaker assembly such that the light guide assembly at least partially overlies the speaker assembly. In one or more embodiments, illumination of the light guide by the light source is controlled in coordination with an operation of the speaker assembly.

### BRIEF DESCRIPTION OF THE DRAWINGS

FIG. 1 is a perspective view of a light guide assembly according to one or more embodiments;

FIG. 2 is a perspective, cross-sectional view of an audio assembly including the light guide assembly and a speaker assembly mounted to a substrate according to one or more embodiments;

FIG. 3 is a top perspective view of the light guide assembly mounted with respect to the substrate according to one or more embodiments;

FIG. 4 is an exploded view of an audio assembly including the light guide assembly, the speaker assembly, a substrate, and a fabric cover according to one or more embodiments;

FIG. 5 is an inverted exploded view of the audio assembly of FIG. 4;

FIG. 6 is a perspective view, partially cut away, of the light guide assembly illustrating a light box and light guide;

FIG. 7 is a perspective view, partially cut away, of the light guide assembly of FIG. 6 with a first portion of the light box removed, the light guide having mirror plating;

FIG. 8 is a perspective view, partially cut away of a light guide assembly with a first portion of the light box removed, the light guide having an end cap;

FIG. 9 is a perspective view of the light guide assembly of FIG. 7 with the cap removed from the light guide, illustrating the mirror plating;

FIG. 10 is a perspective view of the light guide assembly of FIG. 8 with the cap removed from the light guide, illustrating the end cap;

FIG. 11 is a perspective view, partially cut away, of the light box and the light guide illustrating the travel of light rays therethrough according to one or more embodiments;

FIG. 12 is a cross-sectional view of the light box and the light guide of FIG. 11;

FIG. 13 is a perspective view of a light guide assembly according to one or more embodiments, wherein the light guide includes prisms on end portions thereof;

FIG. 14 is a perspective view of a light guide with prisms on the end portions and a central portion thereof according to one or more embodiments;

FIG. 15 is a perspective view of a light guide assembly mounted to the substrate in an offset placement with respect to a speaker assembly according to one or more embodiments; and

FIG. 16 is a graph illustrating the preservation of sound quality with use of the light guide assembly according to one or more embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

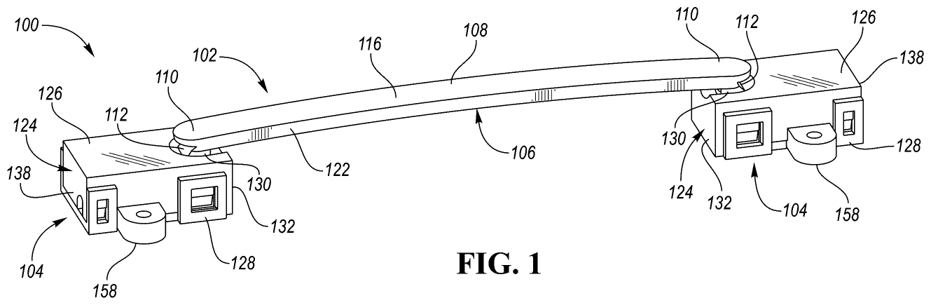

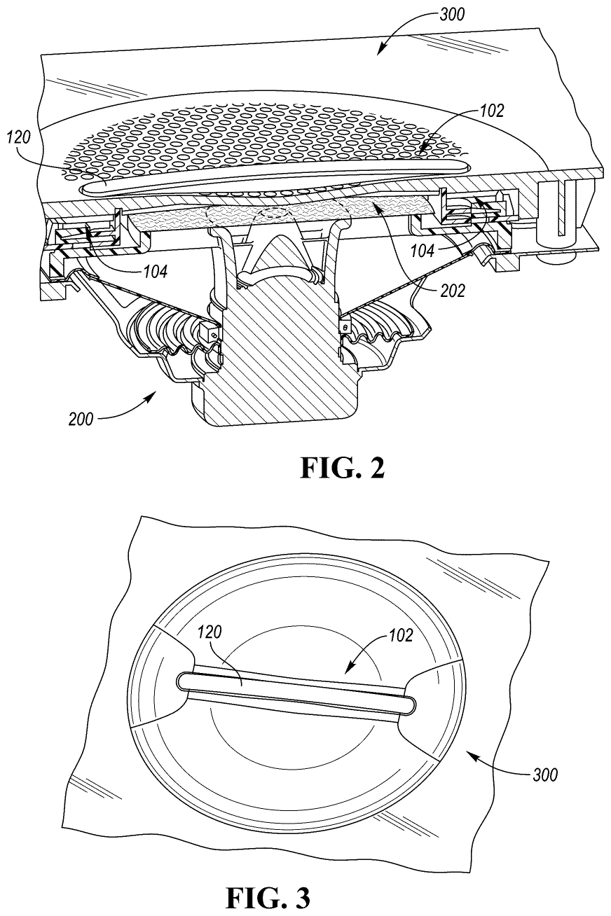

Referring first to FIGS. 1 and 2, a light guide assembly 100 is illustrated for use with a speaker assembly 200, such as in a vehicle. As shown, the light guide assembly 100 includes a light guide 102 and light boxes 104 which are removably connectable to each other. As best shown in FIG. 1, the light guide 102 includes an elongated body 106 having a central portion 108 and end portions 110. The light guide 102 further includes posts 112 that depend downwardly from the body 106 adjacent to each end portion 110. The posts 112 may have a generally circular, rectangular, or other suitable cross-section for secure engagement with the light boxes 104, as described further below.

In one or more embodiments, the body 106 may have the form of a bar, and may be generally flat along its length with a shallow depth, optionally including a slight upward curvature along the central portion 108, such that the central portion 108 of the body 106 is not coplanar with the end portions 110. Accordingly, a low profile of the body 106 may be achieved to prevent degradation of acoustic performance (e.g. interfering with emitted sound waves) when the light guide assembly 100 is coupled to and overlying a speaker assembly 200. Such a low profile of the light guide 102 is also aesthetically pleasing and ergonomic, as the light guide 102 may be designed to protrude only slightly above the surface of a substrate 300 through which the light guide 102 is attached to the light boxes 104, as illustrated in FIGS. 2 and 3.

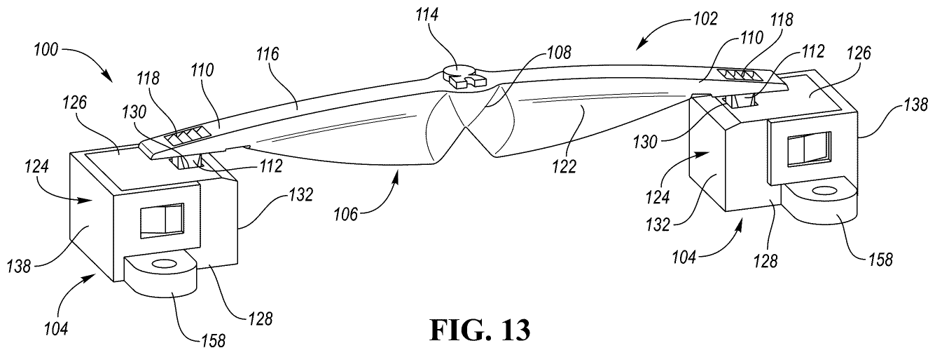

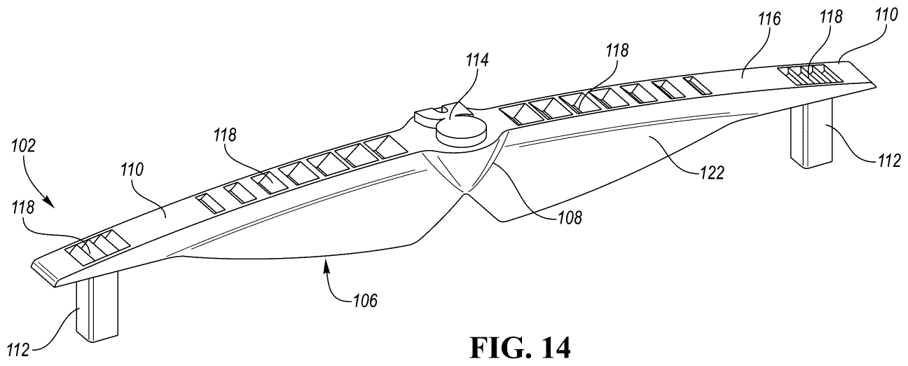

The light guide 102 may be constructed from a translucent material such as, but not limited to, polymethyl methacrylate (PMMA) or another plastic material. Alternately, one or more portions of the light guide 102 could be constructed or treated so as to be less translucent or even opaque compared to other portions of the light guide 102 depending on the illumination effect desired. The body 106 may have a generally uniform thickness along its length as shown in FIG. 1, or it could be thicker in the central portion 108 compared with the end portions, such as in the embodiment of FIGS. 13-14. Of course, it is understood that the light guide 102 is not limited to these configurations, and other configurations of the light guide 102 are fully contemplated.

With continuing reference to FIGS. 13-14, in one or more embodiments the light guide 102 may include a logo 114 (e.g., symbol, text, indicia, etc.), such as on a top face 116 of the body 106, wherein the logo 114 may be translucent (so that the logo 114 can be illuminated) or opaque. In one non-limiting example, the logo 114 could serve as a source identifier for a vehicle or audio manufacturer. The light guide 102 may also include prisms 118 in one or more locations, such as in the central portion 108, at the end portions 110, or both. The placement of the prisms 118 can be used to control the directionality and scattering of light emitted from the light guide 102 onto the surrounding environmental surface (e.g., vehicle panel or interior), thus defining an external light design.

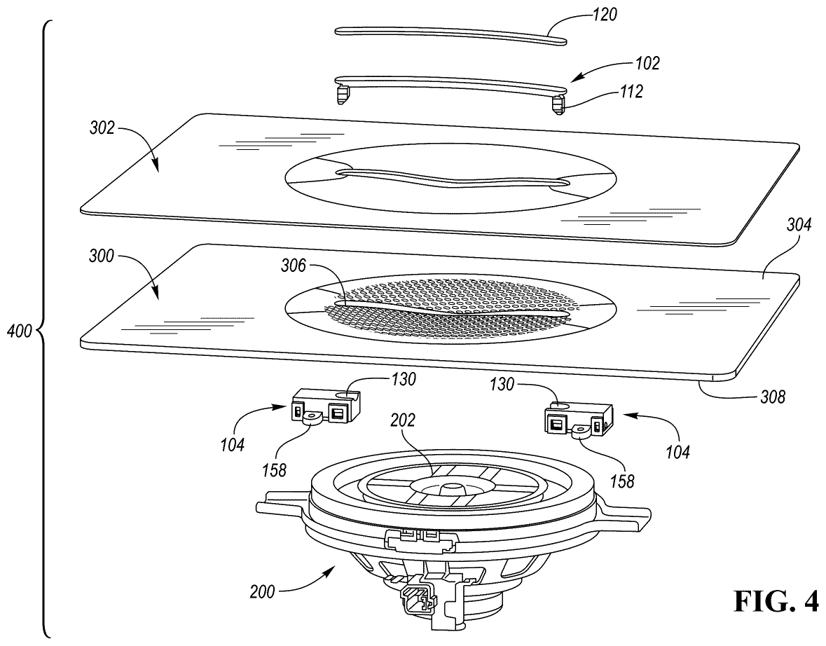

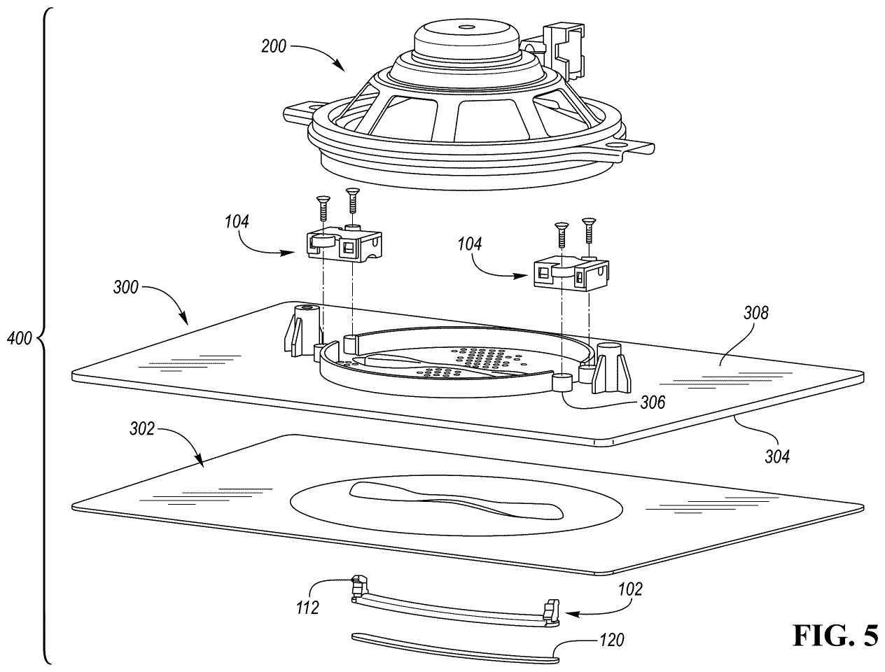

As best shown in FIGS. 2-5, the light guide 102 may include a decorative cap 120 configured to be disposed along the top face 116 of the body 106. The cap 120 may be removably mounted to the body 106, such as via a snap fit or magnetic connection between the cap 120 and the body 106, or alternatively may be attached to the body 106 via adhesive or fasteners. The cap 120 may be constructed from a metallic material, such as aluminum or stainless steel, but could also be constructed from a plastic or other material. If constructed from an opaque material, the cap 120 can function to prevent light from being emitted through the top face 116, such that the light is instead emitted only from side faces 122 of the body 106. The cap 120 may also include a logo 114 (e.g., symbol, text, indicia, etc.) as described above.

Referring again to FIG. 1, the light guide 102 is illuminated via the light boxes 104 removably connected to the body 106, such as at each end portion 110. In this manner, when the light guide assembly 100 is positioned above the speaker assembly 200, the spacing of the light boxes 104 is arranged so as to not overlie the speaker output portion 202 and thus not obstruct the sound output of the speaker assembly 200. Each light box 104 may have a generally rectangular housing 124 with a first portion 126 and a second portion 128. In one non-limiting example, outer dimensions of the light box 104 may be approximately 20.5 mm length×24 mm width×8 mm depth, but other dimensions are fully contemplated. The housing 124 may be constructed from a plastic material such as ABS, but is not limited thereto. Although each light box 104 is depicted herein to have a rectangular shape, it is understood that the light box 104 is not limited to this configuration. Furthermore, although two light boxes 104 are shown and described herein, one at each end portion 110, it is contemplated that the light guide assembly 100 could only include one light box 104.

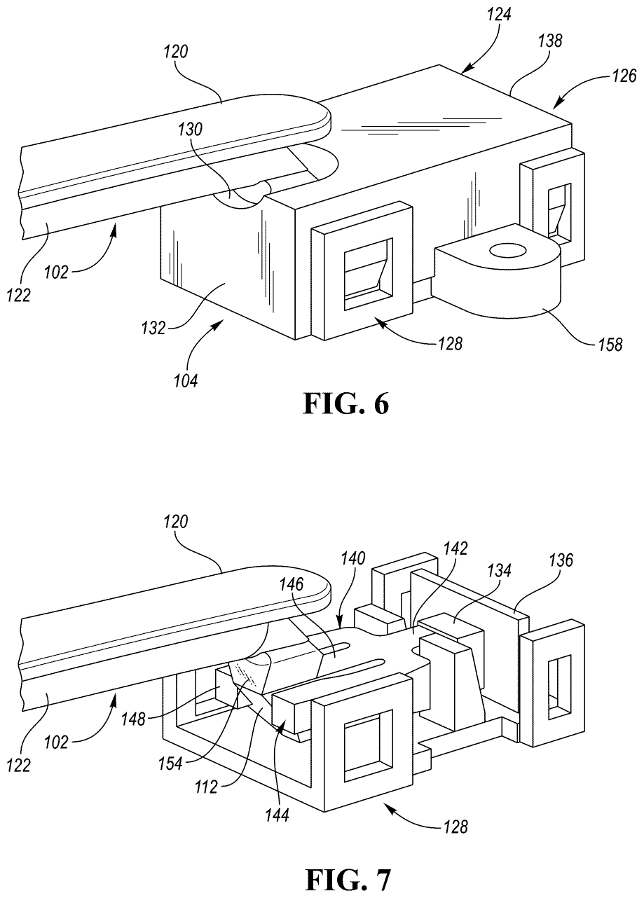

In one or more embodiments, the first portion 126 may form an upper portion of the housing 124 and the second portion 128 may form a lower portion of the housing 124, such as depicted in FIGS. 1 and 6. In another embodiment, as shown in FIG. 13, the first portion 126 may form a first side portion and the second portion 128 may form a second side portion. It is understood that the embodiments of the first portion 126 and the second portion 128 depicted herein are merely exemplary, and that the configuration of the housing 124, the first portion 126, and the second portion 128 are not limited to these examples.

In one or more embodiments, the first portion 126 and the second portion 128 are removably connected to each other. In this way, the light box 104 may be disassembled to allow the light guide 102 (i.e. posts 112) to be inserted and secured in the light box 104 and then removed from the light box 104 when desired. In one or more embodiments, the light box 104 includes a mounting aperture 130 for receiving a post 112 from the light guide 102. In one example, the mounting aperture 130 may be formed at a proximal end 132 of the light box 104 adjacent the light guide 102, such as in the first portion 126. The mounting aperture 130 may be configured to removably receive and secure the post 112 at least partially within the light box 104 when the first portion 126 is assembled to the second portion 128. Alternatively, the first portion 126 may be removed from the second portion 128 for receiving the post 112 at least partially within the light box 104, after which the post 112 may be secured to the light box 104 when the first portion 126 is assembled to the second portion 128. In this latter embodiment, the first portion 126 may be removed from the second portion 128 to remove the post 112 from the light box 104.

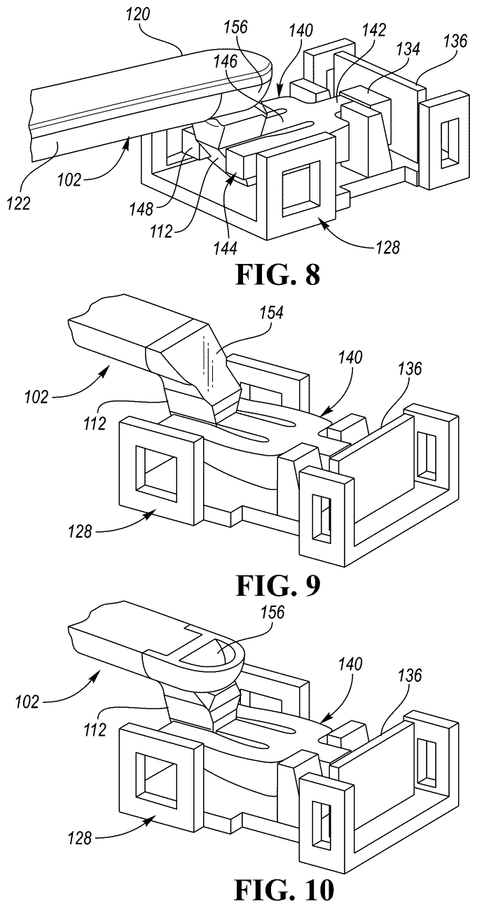

With reference to FIGS. 6-8, an interior of the housing 124, for example the second portion 128, may be configured for mounting various internal components of the light box 104. Each light box 104 includes a light source, such as at least one programmable LED 134 which can be mounted to and controlled via a printed circuit board (PCB) 136 disposed within the light box 104. In one or more embodiments, the at least one LED 134 may include RGB LEDs with additional color mixing. As illustrated in the examples of FIGS. 7 and 8, the PCB 136 may have a vertical orientation at a distal end 138 of the light box 104. The PCB 136 may be controlled via a controller (not shown), such as within a vehicle audio system, for coordinating or synchronizing illumination of the LEDs 134 with the operation of the speaker assembly 200.

In one or more embodiments, a light mixing conduit 140 such as, but not limited to, a fork light guide, may be mounted in the light box 104, such as in the second portion 128. The light mixing conduit 140 includes a first end 142 adjacent to the LED(s) 134 and a second end 144 adjacent to the light guide 102, more specifically the post 112. The light mixing conduit 140 may include a central prong 146 through which light travels and mixes from the at least one LED 134 to the post 112, and outer prongs 148 which may receive the post 112 therebetween to help maintain the post 112 in a desired position within the light box 104. In one non-limiting example, the light mixing conduit 140 may be constructed from PMMA or a similar material. Of course, other configurations of the light mixing conduit 140 are fully contemplated.

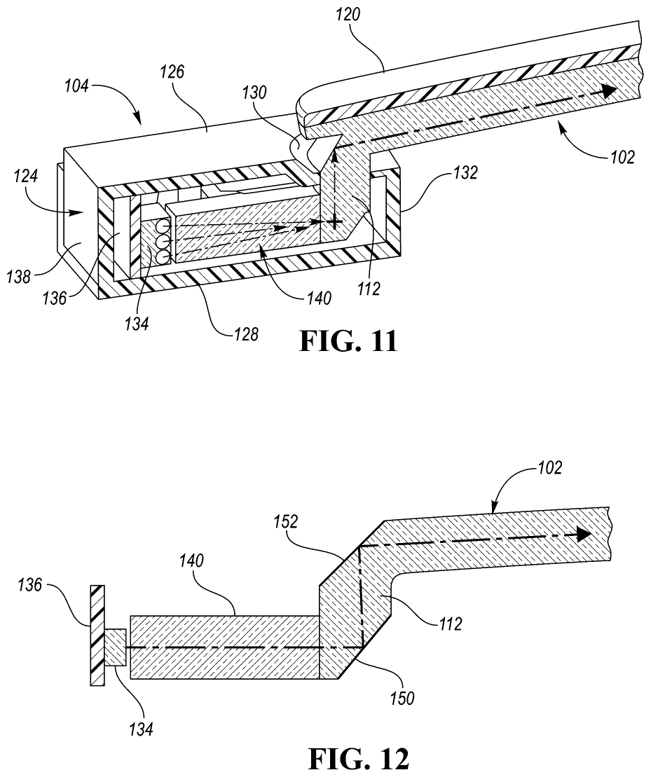

The light boxes 104 are constructed with a length sufficient to mix the RGB colors of the LED(s) 134 to present a uniform color throughout the light guide 102, such as illustrated in FIG. 11. As shown in FIG. 12, the posts 112 and/or end portions 110 of the light guide 102 may include a first internal reflective surface 150 and a second internal reflective surface 152. The first internal reflective surface 150 is configured to reflect light from the at least one LED 134 traveling through the light mixing conduit 140 into the post 112, and the second internal reflective surface 152 is configured to reflect light traveling through the post 112 into the light guide 102. As shown, the first internal reflective surface 150 may be oriented at an angle, such as approximately 45 degrees, with respect to a plane of the light mixing conduit 140, and the second internal reflective surface 152 may be oriented at an angle, such as approximately 45 degrees, with respect to a plane of the light guide 102 at the end portion 110 thereof, wherein a plane of the first internal reflective surface 150 may be substantially parallel to a plane of the second internal reflective surface 152.

As the light from the LEDs 134 in each light box 104 is internally reflected within the posts 112 and/or end portions 110 of the light guide 102, light has the potential to leak from the light guide 102 in these areas. To prevent such light leakage, the posts 112 may include masking elements such as mirror plating 154 (FIGS. 7 and 9) which allows internal reflections to occur within the light guide 102 without leaking light in the end portions 110, as the mirror plating 154 is selective and does not prevent light entry from the LEDs 134. In another embodiment, the masking elements may include opaque end caps 156 (FIGS. 8 and 10) on the end portions 110 which block light from leaking in these regions of the light guide 102.

The light guide assembly 100 may be designed to be modular, such that a plurality of different light guides 102 may be provided and selected from for use with the same light boxes 104. In this way, a plurality of light guides 102 can be manufactured with different branding, light scattering properties, materials, and shapes as long as the distance between the posts 112 is standardized, and then the various light guides 102 can be interchangeable. Since the light boxes 104 have programmable LEDs 134, different illuminations of the same light guide 102 are also possible.

In one or more embodiments, the light boxes 104 may be configured to be coupled to the speaker assembly 200. The light boxes 104 can be coupled via mounting to the speaker assembly, such as with fasteners or adhesive, or the light boxes 104 can be coupled via being integrally formed or molded with the speaker assembly 200. With reference to FIG. 6, each light box 104 may include one or more mounting tabs 158 for securing the light boxes 104 to the speaker assembly 200, or alternatively for securing the light boxes 104 to the substrate 300. In one or more embodiments, the mounting tabs 158 may extend outwardly from the light box 104, such as from the second portion 128 thereof. Of course, other mounting tab configurations or mounting elements for coupling the light boxes 104, and thus the light guide assembly 100, to the speaker assembly 200 and/or substrate 300 are also contemplated.

Returning to FIGS. 2-5, an audio assembly 400 is illustrated wherein the light boxes 104 are disposed beneath the substrate 300 (e.g. panel or wall, such as in a vehicle or for home use), and the light guide 102 is mounted to the light boxes 104 through the substrate 300. The substrate 300 is typically constructed from a plastic material, and in one or more embodiments, an acoustic fabric 302 may be pre-formed into a top surface 304 of the substrate 300. Openings 306 are formed in the substrate 300 which are configured to receive the posts 112 of the light guide assembly 100. In order to assemble the light guide 102 to the light boxes 104, the posts 112 penetrate through the fibers of the acoustic fabric 302, pass through the openings 306 in the substrate 300, and are securely received and retained in the light boxes 104. The light boxes 104 are optimized to have a minimized height and low profile configuration, allowing the speaker assembly 200 to be positioned close to a bottom surface 308 of the substrate 300, which is important to preserve acoustic performance of the speaker assembly 200 and prevent a tunneling effect (internal reflections). In one or more embodiments, with the light boxes 104 mounted below the substrate 300 adjacent to the bottom surface 308 thereof, a distance from the speaker assembly 200 to the top surface 304 of the substrate 300 advantageously may be minimized to between about 7 mm to about 11 mm, for example. Of course, other distances from the speaker assembly 200 to the top surface 304 are also contemplated.

While the light boxes 104 and the speaker assembly 200 are each independently mounted to the substrate 300 in the embodiment of FIGS. 2-5, it is understood that this is only one possible mounting configuration for the audio assembly 400. Alternatively, for example, the light boxes 104 could be mounted to the speaker assembly 200, or the light boxes 104 could be integrally formed (i.e. molded) with the speaker assembly 200, and then the speaker assembly 200 and/or the light boxes 104 could be mounted to the substrate 300.

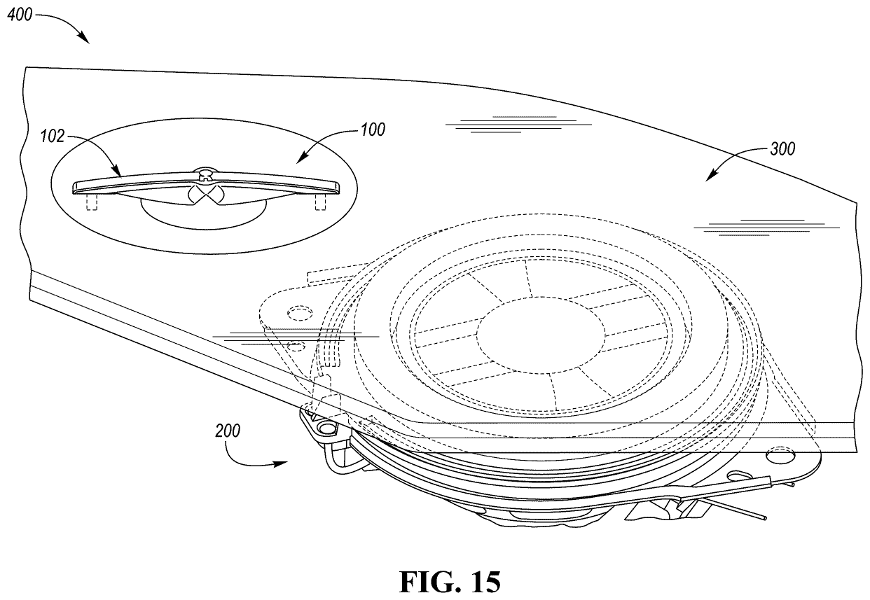

With reference to FIG. 15, instead of an inline, on-axis placement overlying the speaker assembly 200, the light guide assembly 100 may be mounted to the substrate 300 in a position offset or adjacent to a location of the speaker assembly 200. When used in a vehicle, in one or more embodiments, a controller or vehicle control system (not shown) may be used to control illumination of the light guide assembly 100. In one example, a control system strategy could be employed to illuminate a light guide 102 overlying or adjacent to a speaker assembly 200 in current operation. The light guide assembly 100 could also be configured to illuminate with different colors for different audio volumes (amplitudes), and patterns of illumination of the light guide 102 may be coordinated with the audio signal. In one non-limiting example, illumination of the light guide 102 may be coordinated and controlled through a local interconnect network (LIN) system in electrical communication with a speaker amplifier (not shown).

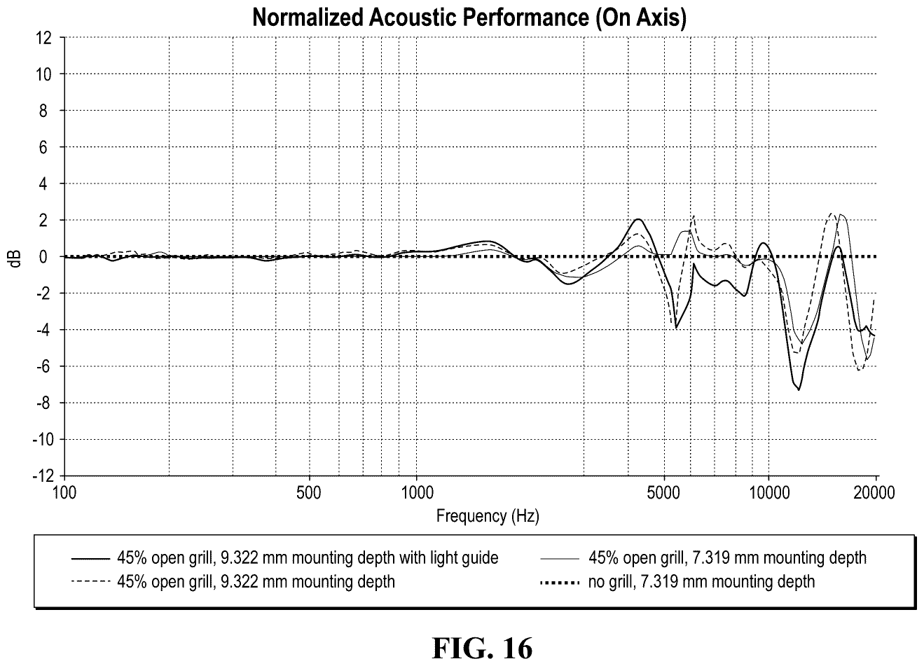

FIG. 16 is a graph which demonstrates the preservation of sound quality with use of the light guide assembly 100 according to one or more embodiments. The graph depicts sound level as a function of frequency, normalized to the output of a speaker assembly 200 with no grill at a 7.319 mounting depth of the light boxes 104 (dotted line trace). The bold solid line trace represents results for the light guide assembly 100 with the light guide 102 overlying a speaker assembly 200 with a 45% open grill at a 9.322 mm mounting depth of the light boxes 104. The dashed line trace represents results for a speaker assembly 200 with a 45% open grill but no light guide 102 and a 9.322 mm mounting depth of the light boxes 104. Lastly, the remaining solid line trace represents results for a speaker assembly 200 with a 45% open grill at a 7.319 mm mounting depth of the light boxes 104. As shown, the sound output of the speaker assembly 200 with the light guide 102 (bold line trace) is fairly indistinguishable from the other tested scenarios which did not include a light guide 102, especially below 5 kHz.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A light guide assembly for use with a speaker assembly, the light guide assembly comprising:
a light guide including an elongated body having end portions with a central portion therebetween, the body having a post depending downwardly from each end portion; and
light boxes removably connectable to the posts, each light box having a light source disposed therein for illuminating the light guide, wherein illumination of the light guide by the light source is controlled in coordination with an operation of the speaker assembly.

2. The light guide assembly of claim 1, wherein the light boxes are configured to be coupled to the speaker assembly.

3. The light guide assembly of claim 1, wherein the light boxes are integrally formed with the speaker assembly.

4. The light guide assembly of claim 1, wherein the light source includes at least one programmable LED mounted to and controlled via a printed circuit board (PCB) disposed within each light box.

5. The light guide assembly of claim 1, wherein each light box has a generally rectangular housing with a first portion and a second portion removably connected to each other, each light box including a mounting aperture for receiving the post from the light guide.

6. The light guide assembly of claim 1, wherein the light guide includes a cap configured to be disposed along a top face of the body.

7. The light guide assembly of claim 6, wherein at least one of the body and the cap includes a logo thereon.

8. The light guide assembly of claim 1, wherein each light box includes a light mixing conduit mounted therein and having a first end adjacent to the light source and a second end adjacent to the post.

9. The light guide assembly of claim 1, wherein the light guide includes prisms on the body to control light emitted from the light guide.

10. The light guide assembly of claim 1, wherein the posts include masking elements including one of mirror plating or opaque end caps to prevent light leakage from the end portions of the light guide.

11. A light guide assembly configured to be mounted to a speaker assembly, the light guide assembly comprising:
a light guide including an elongated body having end portions with a central portion therebetween, the body having a post depending downwardly from each end portion; and
light boxes integrally formed with the speaker assembly and removably connectable to each of the posts, each light box having at least one programmable LED mounted to and controlled by a printed circuit board (PCB) for illuminating the light guide, each light box having a generally rectangular housing with a first portion and a second portion removably connected to each other, each light box including a mounting aperture for receiving the post from the light guide to mount the light guide assembly to the speaker assembly.

12. (canceled)

13. The light guide assembly of claim 11, wherein the light guide includes a cap configured to be disposed along a top face of the body, wherein at least one of the body and the cap includes a logo thereon.

14. The light guide assembly of claim 11, wherein each light box includes a light mixing conduit mounted therein and having a first end adjacent to the at least one programmable LED and a second end adjacent to the post.

15. An audio assembly configured to be mounted to a substrate having a top surface and a bottom surface, the audio assembly comprising:
a speaker assembly configured to be mounted below the bottom surface of the substrate; and
a light guide assembly including
a light guide configured to be disposed above the top surface of the substrate, the light guide including an elongated body having end portions with a central portion therebetween, the body having a post depending downwardly from each end portion and configured to extend through openings in the substrate, and
light boxes each including a light source disposed therein for illuminating the light guide, the light boxes configured to be mounted below the bottom surface of the substrate and to receive the posts to removably connect the light guide thereto, wherein the light boxes are coupled to the speaker assembly such that the light guide assembly at least partially overlies the speaker assembly.

16. (canceled)

17. The audio assembly of claim 15, wherein the light source includes at least one programmable LED mounted to and controlled via printed circuit board (PCB) disposed within each light box.

18. The audio assembly of claim 15, wherein each light box has a generally rectangular housing with a first portion and a second portion removably connected to each other, and wherein each light box includes a mounting aperture for receiving the post from the light guide to mount the light guide assembly to the speaker assembly.

19. The audio assembly of claim 15, wherein the light guide includes a cap configured to be disposed along a top face of the body, wherein at least one of the body and the cap includes a logo thereon.

20. The audio assembly of claim 15, wherein illumination of the light guide by the light source is controlled in coordination with an operation of the speaker assembly.
